(19) United States
(12) Patent Application Publication
(10) Pub. No.: US 2026/0357802 A1
(43) Pub. Date: Nov. 12, 2026

(54) MONITORING HEALTH OF VALVES IN PISTON-BASED COMPRESSORS

(71) Applicant: ATLAS COPCO AIRPOWER, naamloze vennootschap, Wilrijk (BE)

(72) Inventors: Wim Tirry, Wilrijk (BE); Ludovic Melis, Lille (FR); Kris Vermeulen, Wilrijk (BE); Thomas De Jonghe, Wilrijk (BE)

(21) Appl. No.: 19/328,610

(22) Filed: Sep. 15, 2025

(30) Foreign Application Priority Data
May 9, 2025 (FR) 2504946
Jun. 6, 2025 (FR) 2506136

(51) Int. Cl. F04B 51/00; F16K 37/00; G05B 13/02; G08B 21/18

(52) U.S. Cl. CPC F04B 51/00; F16K 37/0083; G05B 13/0265; G08B 21/182

(57) ABSTRACT

A device may receive, from a first sensor mounted to a compressor, first sensor data associated with vibrations within the compressor, and receive, from a second sensor mounted adjacent to a piston rod of the compressor, second sensor data associated with a displacement of the piston rod. Based on the second sensor data, a start and an end of a compression cycle of the compressor may be determined. Using the first data, a map is generated that indicates the vibrations between the start and the end of the compression cycle. One or more characteristics of the vibrations are determined based on the map to determine a damage to the valve. At least one of an operation of the compressor to be adjusted or a notification is output associated with the damage to the valve.

### CROSS-REFERENCE TO RELATED APPLICATION

This patent application claims priority to FR Patent Application No. FR 2 504 946 filed May 9, 2025, and to FR Patent Application No. FR 2 506 136, filed Jun. 6, 2025, which applications are fully incorporated herein by reference.

### BACKGROUND

Compressors include one or more valves that control suction and discharge. For example, suction valves allow air to enter a compression chamber during intake while discharge valves permit air to exit the compression chamber during discharge. Overtime, the disk valves degrade, requiring maintenance or replacement. Oftentimes, the valves are damaged before routinely scheduled maintenance, which may lead to inefficiencies and/or downtime. Prematurely performing maintenance and/or replacement, however, results in unnecessary downtime and/or added costs.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an example environment including a compressor and an example device that may be used to monitor a health of one or more valves of the compressor, according to an embodiment of the present disclosure.

FIG. 2 illustrates an example diagram associated with generating scores associated with a health of one or more valves of the compressor, according to an embodiment of the present disclosure.

FIG. 3 illustrates an example signal associated with vibrations measured during a compression cycle, according to an embodiment of the present disclosure.

FIGS. 4A-4C illustrate maps associated with a health of one or more valves of the compressor, according to an embodiment of the present disclosure.

FIGS. 5-7 illustrate example processes associated with determining a health of one or more valves of the compressor, according to an embodiment of the present disclosure.

FIG. 8 illustrates an example process for generating, training, and using machine learning model(s) associated with detecting valve damage, according to an embodiment of the present disclosure.

### DETAILED DESCRIPTION

This application is directed, at least in part, to systems and methods that monitor a health of one or more valves in a compressor, according to an embodiment of the present disclosure. In an embodiment, at least one vibration sensor may be mounted to the compressor and generate vibration signals associated with experienced vibrations on, within, or about the compressor. In addition, a reference sensor may generate a reference signal that is used to determine a compression cycle of the compressor. For example, the reference signal may be used to determine intake, compression, and/or discharge periods of the compression cycle. The reference signal permits a map to be generated that indicates experienced vibrations throughout the different periods of the compression cycle. For valves that are healthy, certain periods of the compression cycle may have expected vibrations, such as during intake and discharge. However, for damaged valves, vibrations may occur at unexpected periods, deviate from expected amplitudes, and/or deviate from expected frequencies. These may be referred to as anomalies. Analysis of the map may be used to generate damage scores that are indicative of the health of the valve. The valves may be scheduled for replacement or maintenance based on the damage scores. Accordingly, the systems and methods herein may be used to efficiently and resourcefully schedule valves for maintenance or replacement.

In an embodiment, the compressor may represent any suitable compressor, such as an oil-free compressor, gas compressor (e.g., air, nitrogen, hydrogen, CO₂, etc.), reciprocating compressor, etc. In an embodiment, the compressor may represent a piston-based compressor. The compressor may include any number of valves, such as any number of intake valves and discharge valves. Other valves may also be included. The compressor may also include any number of compression chambers. In addition, any number of compressors may work in unison together. For example, piston rods may be disposed across any number of compressors, or compressor chambers, and may couple to a common crankshaft. Regardless of the specific embodiment, intake and discharge valves may control the intake and discharge of air, fluid, etc., into and out of the compression chambers, respectively. In an embodiment, the valves may represent any suitable valve, such as disc valves, poppet valves, reed valves, plate valves, etc.

The vibration sensor(s) may be installed, mounted, or otherwise disposed at any suitable location on the compressor. For example, the vibration sensor(s) may be installed on a valve cover of the valves (e.g., intake valve cover, discharge valve cover, etc.), a body (e.g., housing) of the compressor, etc. However, the vibration sensor(s) may be installed at other locations, such as on the cylinder, body, housing, etc., of the compressor. As noted above, the compressor may have any number of compression chambers, and in such instances, the vibration sensor(s) may be installed on the covers of each intake and discharge valve. In an embodiment, the vibration sensor(s) may measure frequency, acceleration, displacement, etc. In an embodiment, the number of vibration sensor(s) may increase redundancy in detecting the vibrations and determining the health of the compressor.

The reference sensor(s) may be installed, mounted, or otherwise disposed at any suitable location on the compressor. In an embodiment, the reference sensor(s) may include a rod drop sensor, a proximity sensor, a tachometer (e.g., laser, magnetic, etc.), an encoder, an axial vibration sensor, an ultrasonic sensor, or a dynamic pressure sensor. When embodied as a rod drop sensor, the reference sensor may be disposed adjacent to a piston rod disposed between a crankshaft and a piston. The rod drop sensor may measure a distance (e.g., gap) disposed between the rod drop sensor and the piston rod. As the piston rod moves, for example, between intake, compression, and discharge periods of the compression cycle, the rod drop sensor detects a change in position. The change in position measured by the rod drop sensor may be used to determine the compression cycle. For example, patterns in the signal generated by the rod drop sensor may be analyzed to determine a full compression cycle (e.g., intake, compression, discharge). The patterns may repeat within the signal to understand which periods of the compression cycle are associated with intake, compression, discharge, etc. This permits understanding when the compressor is intaking, compressing, and discharging. Given that the compression cycle is repetitive, patterns are recognizable through the reference signal to understand the start and end of respective compression cycles (i.e., one complete or full compression cycle). However, although described in relation to the rod drop sensor, the compression cycle may be similarly understood by analyzing patterns from signals generated by other reference sensors. Moreover, any number of reference sensor(s) (e.g., two, three, etc.) may be installed on the compressor. In an embodiment, for example, two rod drop sensors may be installed to measure locations of the piston rods. The reference sensor(s) may also be disposed adjacent to connecting rods.

The vibration signal and the reference signal may be generated synchronously. Capturing the vibration signal and the reference signal synchronously allows the experienced vibrations to be correlated or otherwise associated with certain periods of the compression cycle. For example, vibrations during intake, compression, and/or discharge periods may be determined by synchronizing the vibration signal and the reference signal. In an embodiment, a digital converter may synchronize the vibration signal and the reference signal. For example, when the reference sensor detects the start of a new compression cycle, the vibration sensors may be triggered to generate the vibration signals. Knowing when the compression cycle starts (e.g., after each complete or full compression cycle) may be used as a trigger for the vibration sensor to generate the vibration signal.

In embodiments where a plurality of vibration sensors are implemented, the plurality of vibration signals across the plurality of vibration sensors may be synchronized with the reference signal. In other words, because a plurality of vibration sensors may be installed across the compressor, the plurality of vibration sensors may be synchronized with the reference sensor. Given the synchronization, the measured vibrations are detectable at the same instances in time across the vibration signals. Where multiple reference sensor(s) are used, each of the reference sensor(s) may be used to measure the location of the piston rod for each compressor chamber. For example, a first reference sensor disposed adjacent to a first piston rod may generate a first reference signal, and a second reference sensor disposed adjacent to a second piston rod may generate a second reference signal. Each of the reference signals may additionally be used to determine vibrations for any number of signals generated by vibration sensor(s). For example, in the case of the first reference sensor, the first reference signal may be used to determine vibrations from a first vibration sensor, a second vibration sensor, etc. of a first cylinder. The second reference sensor may be used to determine vibrations from a third vibration sensor, a fourth vibration sensor, etc., of a second cylinder.

In an embodiment, the vibrations may be mapped against the compression cycle. For example, throughout the compression cycle, as determined via the reference signal, the vibrations captured by the vibration sensors may be mapped as a function of time. This is used to understand the vibrations that occur throughout the compression cycle. For a given compression cycle, vibrations may occur during intake, compression, discharge, etc. The map may indicate the timing of the vibrations and their intensity. In an embodiment, rather than mapping the vibrations as a function of time, the vibrations may be mapped as a function of angular rotation or the position of the crankshaft. For example, the angular position or displacement of the crankshaft of the compressor may be mapped from 0 to 360 degrees, and with each angular position, the vibration may be mapped accordingly.

The map, which may represent a 2D map, graph, plot, etc., may be analyzed to determine vibrations throughout the compression cycle. For example, the map may have an X-axis that represents time (e.g., in seconds) or angular position (e.g., in degrees). The map may have a Y-axis that represents energy, voltage, frequency, acceleration, etc., associated with the vibration signal. The maps generated for each compression cycle may be compared against one another to determine patterns. A comparison of the maps is used to determine expected vibrations during the periods of the compression cycle. For example, throughout the compression cycle, some vibrations are expected, such as during the opening and closing of the valves during intake and discharge. During these periods, as represented on the X-axis, vibrations may be sensed and correspondingly mapped. The normalcy of these vibrations may be determined over time by comparing the vibrations across different compression cycles. Thresholds may be established for vibration amplitudes, as well as the period of time, or angular position, where the vibrations are expected to occur. In this manner, a reference or baseline map may be generated for the compression cycle, where the baseline map illustrates the expected vibrations, both in amplitude and duration, throughout the compression cycle. This reference or baseline map may be generated upon commissioning of a new compressor, after the compressor has been serviced, etc. This assumes that the valves are healthy for the purposes of generating the reference or baseline map to determine when the valves become damaged. The baseline map may be used to determine reference characteristic(s) of the vibrations throughout the compression cycle. The reference characteristic(s) may be associated with each period of the compression cycle, and indicate expected vibrations, expected durations of the vibrations, a timing of the vibrations, etc.

Comparison of the maps may also be used to determine deviation abnormalities, etc. The detection of these deviations, such as when vibrations have amplitudes greater than the predetermined thresholds, when vibrations occur outside expected periods of time, etc., may indicate damaged valves. For example, the valves may flutter and cause unexpected vibrations to occur. These unexpected vibrations may be identified through a comparison to the reference characteristic(s). Analysis of a map for a particular compression cycle may indicate unexpected vibrations by comparing the map with previous maps from previous compression cycles. When a deviation is sensed, this may be indicative of unexpected vibrations, damaged valves, and/or unhealthy valves. In addition, where vibrations are expected but are absent from the map, this too may be indicative of damaged valves.

In an embodiment, the compressor may have different operating parameters, such as pressures, speeds, temperatures, etc. At these different operating parameters, the vibration(s) may be characterized. In an embodiment, reference characteristics may exist for each of the operating parameters in order to accurately determine unexpected vibration(s). This may permit certain vibration(s) to be filtered or ignored to reduce false positives or vibration(s) that are otherwise expected to occur at different operating parameters.

In an embodiment, the severity of the damage or health of the valve may be associated with both the time and intensity of the vibration, as measured on the X and Y axis of the map, respectively. For example, when vibrations occur at times different than expected, when the vibrations have greater amplitudes than expected, or when the vibrations occur at different frequencies than expected, this may indicate an unhealthy valve. Moreover, when multiple vibration sensors are used, each vibration sensor generates an associated vibration signal that is used to determine an associated map. The vibration signals, or the maps, associated with each vibration sensor may be compared to determine whether a vibration was detected. In other words, a first map associated with a first vibration sensor may be compared to a second map associated with a second vibration sensor to determine whether the same vibration was sensed. This increases the accuracy in detecting vibrations, whether expected or unexpected.

In an embodiment, rather than generating a map associated with each compression cycle, maps may be generated for a plurality of compression cycles. For example, a map may indicate the averaged vibrations that have occurred over a prior internal, a certain number of compression cycles, etc. Similarly, this map may be compared to previous maps to determine whether the vibrations are expected or unexpected.

In an embodiment, ML model(s) may be utilized to determine the vibrations. For example, the ML model(s) may receive the maps and analyze the maps to determine expected vibrations and unexpected vibrations. Additionally, or alternatively, the ML model(s) may receive the vibration signals and the reference signals to generate the maps. As briefly introduced above, the expected vibrations may occur at expected periods in time (e.g., intervals, durations, times, etc.), while unexpected vibrations may occur at unexpected periods in time. Moreover, the expected vibrations may have expected or normal vibrations throughout the expected periods of time, while the unexpected vibrations may have unexpected or abnormal vibrations throughout the unexpected periods in time. That is to say, at certain periods in time, there are expected or normal levels of vibration, while for some other instances, but these same periods in time, the levels of vibration might be unexpected or abnormal. The ML model(s) may identify characteristic(s) of the map and may assess the characteristic(s) in comparison to the reference characteristic(s) to determine expected vibrations and unexpected vibrations. For example, between a first time and a second time , the ML model(s) may identify a first vibration or series of vibrations as an intake valve opening and closing. Rather than being associated with a time, between a first angular position and a second angular position of the piston, the ML model(s) may identify the first vibration or series of vibrations as an intake valve opening and closing. The same may be true for time periods or angular positions associated with a discharge valve opening and closing. Moreover, some vibrations may occur while the valves are not opening or closing, such as during a compression period. Regardless, the ML model(s) may be trained to identify characteristic(s) of a given map and may assess those characteristic(s) in comparison to the reference characteristic(s) from previous maps to determine both expected vibrations and unexpected vibrations.

The ML model(s) may be trained from a database (e.g., historical data, such as vibration signals that contained expected vibrations, unexpected vibrations, etc.) to analyze the vibration signals captured by the vibration sensor(s). The ML model(s) may determine characteristic(s) of the vibration, such as the duration of the vibrations, a timing of the vibrations, a frequency of the vibrations, an amplitude of the vibrations, etc., and may assess these characteristic(s) in relation to the reference characteristics(s). In an embodiment, the reference characteristic(s) may be based on the type of the compressor, the number of valves of the compressor, operating conditions of the compressor (e.g., temperature, pressures, etc.), an environment of the compressor (e.g., altitude, humidity, etc.), and so forth. Moreover, the reference characteristic(s) may be associated with valves that are healthy and valves that are unhealthy. Training the ML model(s) on both types of reference characteristic(s) may increase an accuracy in detecting both healthy valves and unhealthy valves.

As part of the ML model(s) analyzing the vibration signals, the ML model(s) may label the characteristic(s) of the vibration that indicates whether the characteristic(s) are expected or unexpected. In an embodiment, an output of the ML model(s) may indicate whether the compressor has an unexpected vibration, an expected vibration, characteristic(s) associated therewith, etc. In an embodiment, the ML model(s) may generate scores associated with the characteristic(s). For example, the ML model(s) may generate scores associated with a presence of expected vibrations or unexpected vibrations. If the scores are greater than a threshold, the ML model(s) may have a threshold confidence that the vibrations are expected or unexpected. The scores may be associated with individual vibrations throughout the compression cycle, where the individual scores may be compared against respective thresholds to determine whether the vibrations are expected or unexpected.

The ML model(s) may also be trained to determine damage scores, where the damage scores indicate the severity or degree associated with a damaged or unhealthy valve. For example, the damage scores may indicate a degree by which the vibration is greater than expected vibrations or thresholds (e.g., an amount over the thresholds). In an embodiment, the damage score may be output by the ML model(s) and may be generated through the comparison of the characteristic(s) with the reference characteristic(s). In an embodiment, the greater the damage score, the more severe the damage. The damage score may, therefore, be associated with the severity of the vibration and how unexpected the vibration is, whether in amplitude or duration, compared to the reference characteristic(s). Rather than generating a damage score, the ML model(s) may output a health score that is associated with a health of the valves.

The damage scores may be generated for each valve of the compressor. For example, knowing periods of the compression cycle that correspond to intake, compression, and discharge, certain vibrations that occur over these periods may be associated with an intake valve or a discharge valve. This means that different portions of the compression cycle may be associated with different valves, and vibrations that occur within these different portions may be used to generate a damage score associated with the respective valves. Depending on the number of compression chambers in the compressor, the ML model(s) may determine any damage scores for the valves across the compression chambers.

When multiple vibration sensors are used, the ML model(s) may process the multiple vibration signals to generate the damage scores. Here, however, the damage scores associated with the valves may be weighted. For example, when generating a damage score for a first valve, a damage score determined from a first vibration sensor positioned adjacent to the first valve may be weighted more heavily than a damage score determined from a second vibration sensor positioned adjacent to a second valve. While both the first vibration sensor and the second vibration sensor may sense the given vibration, because the first vibration sensor may be located closer in proximity to the first valve, the damage score determined using the vibration signal from the first vibration sensor may be weighted more heavily than the vibration signal from the second vibration sensor. Similarly, when generating a damage score for the second valve, a damage score determined using the vibration signal from the second vibration sensor positioned adjacent to the second valve may be weighted more heavily than a damage score determined using a vibration signal from the first vibration sensor.

In instances with more than one vibration sensor, the damage scores may be combined to generate a cumulative damage score for each valve. In an embodiment, the cumulative damage scores may be used to generate an overall damage score for the compressor. For example, for a compressor with multiple valves with independent cumulative damage scores for each valve, the cumulative damage scores may be combined to generate the overall damage score for the compressor. As an example, if a compressor has four valves with cumulative damage scores of 80, 90, 85, and 90, the overall damage score for the compressor may be 86.25 (where the cumulative damage scores are added and divided by the number of valves). Other methods for determining the overall damage score may be utilized. For example, if one valve has a high damage score (e.g., 90), while the other valves have a low damage score (e.g., 40), the high damage score may be weighted more heavily.

The damage scores and/or the cumulative damage scores may be represented numerically (e.g., 0 to 100), stage (e.g., good, bad, etc.), visually (e.g., red, yellow, green, etc.), and so forth. However, rather than generating damage scores for each valve, damage scores may only be generated for a subset of the valves. The overall damage score may indicate the health of the compressor as a whole, as compared to individual valves of the compressor. However, the overall score may be discretized to determine the health or status of individual valves. This permits a known understanding of which valves of the compressor are damaged, in need of repair, and/or in need of replacement.

While the above discussion is with regard to the ML model(s) analyzing the maps, in an embodiment, the maps may be analyzed by operators, technicians, etc. In this sense, the maps may be machine-digestible or human-digestible in order to discern when repair, maintenance, etc., is warranted. In an embodiment, the ML model(s) may label certain characteristic(s) of the maps to permit operators to analyze the map more effectively. Additionally, or alternatively, operators (or humans) may be used to label the maps in order to train the ML model(s).

In an embodiment, one or more transformations may be made to the sensor data to permit the ML sensor data to be input to the ML model(s). The ML model(s) may be trained from multiple datasets and/or different stages of training. For example, the ML model(s) may be trained using a first training dataset, and create a second training dataset for a second stage of training. The ML model(s) may therein be retrained using the second training dataset. This iterative training, whereby the ML model(s) are retrained from outputs, may reduce false positives and/or inaccurate detection of undamaged valves or damaged valves. For example, in instances where valves are incorrectly identified as being damaged, or undamaged, these results may be used to retrain the ML model(s) for more accurate detection (or reduce false positives) in future instances.

In an embodiment, the vibration signals may be analyzed independent of the reference signals. For example, the ML model(s) may analyze the vibration signals over periods of time, and compare the vibration signals, to determine deviations and anomalies. In this example, the reference signals may not be used to determine the start and end of a compression cycle. Comparison of the vibration signals, however, may be used to determine the anomalies.

In an embodiment, the systems and methods as described herein may be implemented by a device. For example, the device may be an integrated or incorporated component of the compressor and may be communicatively coupled to the vibration sensors, the reference sensor, and/or other components of the compressor (e.g., motors, sensors, switches, etc.). In this embodiment, the device may monitor the compressor in real-time, constantly or at predetermined times/intervals, to determine the health of the valves and/or the compressor. Alternatively, the device may be separate from the compressor, such as a portable device that is transported to the compressor. The device may be utilized by a technician during service visits and connected to the vibration sensors, reference sensors, etc., via cables, wires, ports, connectors, etc. Similar to the embodiment of the integrated device, upon connection, the embodiment of the portable device may receive the signals from the vibration sensors and the reference sensors to determine the health of the valves and/or the compressor.

The device may communicatively couple to one or more additional devices. For example, based at least in part on detecting an unexpected vibration, the device may send a notification to one or more additional devices. In response, a technician may be dispatched or a task may be automatically created service or replace the valves, for example. In an embodiment, the device may continuously transmit the signals, data, scores, etc., whether indicative of expected vibrations or unexpected vibrations, to the additional devices. In an embodiment, the device may transmit unprocessed (e.g., raw) signals, or processed signals. Moreover, the device may transmit compressed signals, or a portion of the vibration signals generated by the vibration sensor(s). In an embodiment, rather than transmitting signals, the device may transmit scores (e.g., data) associated with a health of the valves, or characteristics associated with the vibrations.

In an embodiment, the device may be configured to transmit signals or otherwise control the operation, either remotely or directly, of the compressor based on the scores. For example, to prevent damage, efficiencies, etc., the device may instruct the compressor to power down, reduce in RPM, pressure, etc., based at least in part on the damage scores. As another example, when the valves of the compressor are damaged, the help of other compressors within the environment may be enlisted. A first compressor with a damaged valve may power down, or adjust its operational parameters, while a second compressor with undamaged valves, or healthier valves, may adjust its operational parameters to account for the adjustment to the first compressor. The second compressor may increase its speed, pressure, etc., as a way to make up for the adjusted operational parameters of the first compressor.

Additionally, a manual operator may also receive the signal, or a message that enables the manual operator to override the notification for a temporary period of time. For example, if the operator believes that the compressor is safe to operator for the temporary period of time, the manual operator may perform an override function and permit the compressor to operate temporarily. The device may also include I/O components, such as lighting elements, a display, etc., configured to output the notifications associated with the health or status of the compressor.

In an embodiment, whether a component of the compressor or separate from the compressor, the device may communicatively couple to a remote system. The remote system may be configured to perform any or all of the operations described herein. In addition, split processing may occur between the device and the remote system. For example, the device may transmit the vibration signals, whether compressed, unprocessed, etc., to the remote system for analysis. The remote system, in turn, may utilize the ML model(s) to analyze the vibration signals in comparison to the reference signals to determine the health of the valves, the health of the compressors, etc. As another example, the device may transmit the scores to the remote system. In turn, the remote system may determine actions, notifications, etc., based at least in part on the scores. One or more intermediary devices communicatively coupled to the device, the compressor, the remote system, etc., may also be utilized.

Although the above discussion is with regard to utilizing the reference sensor to determine the compression cycle, other sensors or methods may be used to determine the compression cycles for mapping the vibrations. For example, RPMs of the compressor may be estimated from the vibration sensor(s). The RPMs may be used to generate a window (e.g., range) that is equal to a single process of the compression cycle (e.g., one full rotation).

The systems and methods as described herein may be utilized for periodic monitoring, continuous monitoring, and/or for other purposes. For example, the systems and methods may evaluate a health of valves, identify existing damage, and/or prevent unnecessary replacement and/or maintenance of otherwise healthy valves. The systems and methods may also provide a real-time assessment of valve health as a way to issue warnings if damage and/or inefficiencies are detected. Moreover, the systems and methods herein may enhance operational parameters of the valve, such as tuning, when valves are open and closed, etc.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting embodiments. The features illustrated or described in connection with one embodiment may be combined with the features of other embodiments. Such modifications and variations are intended to be included within the scope of the appended claims.

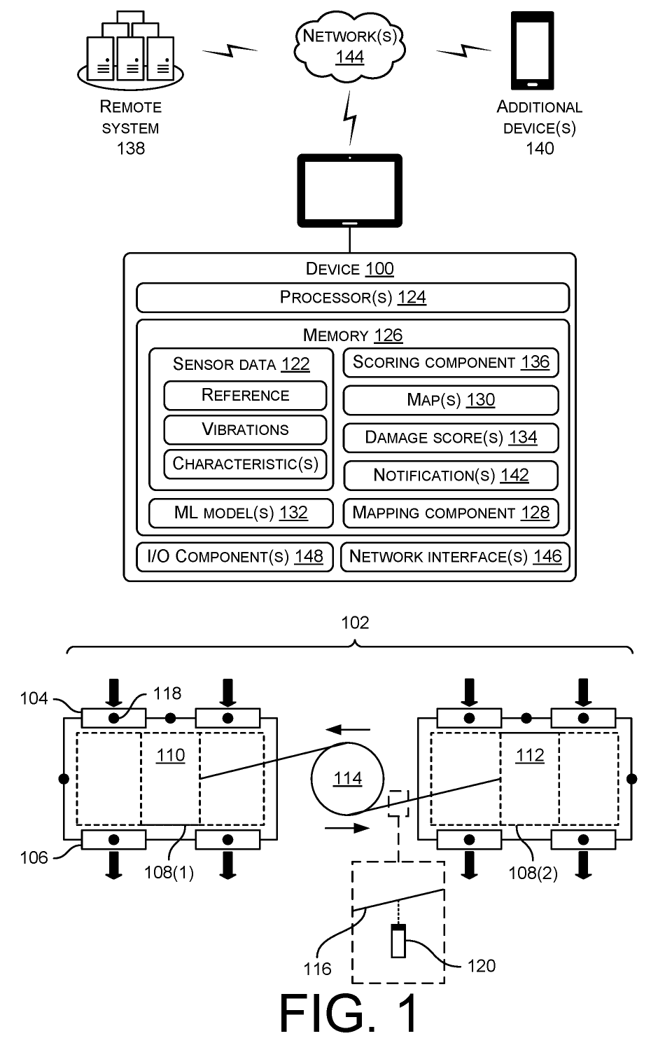

FIG. 1 illustrates an example device 100 that may be used to monitor a compressor 102, according to an embodiment of the present disclosure. In an embodiment, the compressor 102 may represent any suitable compressor, such as a piston compressor. The compressor may include any number of valves, such as any number of intake valves 104 and discharge valves 106. The compressor may also include any number of compression chambers 108, such as a first compression chamber 108(1) and a second compression chamber 108(2). In such instances, the intake valves 104 and discharge valves 106 may control the intake and discharge of air, gases, etc., into and out of the compression chambers 108, respectively. In an embodiment, the intake valves 104 and the discharge valves 106 may represent any suitable valve, such as disc valves, poppet valves, reed valves, plate valves, etc.

Specifically, as shown in FIG. 1, a first piston 110 may be disposed in the first compression chamber 108(1) and a second piston 112 may be disposed in the second compression chamber 108(2). The first piston 110 and the second piston 112 may couple to a crankshaft 114 via piston rods 116, respectively. Rotation of the crankshaft 114 imparts movement to the first piston 110 and the second piston 112, between ends of the first compression chamber 108(1) and the second compression chamber 108(2), respectively. Moreover, during movement of the first piston 110 and the second piston 112, the intake valves 104 and the discharge valves 106 open and close. For example, although not individually labeled, the first compression chamber 108(1) is shown having a first intake valve, a second intake valve, a first discharge valve, and a second discharge valve, while the second compression chamber 108(2) is shown having a first intake valve, a second intake valve, a first discharge valve, and a second discharge valve. However, although a particular arrangement of the compressor 102 is shown, the compressor 102 may include additional or alternative compression chambers 108, intake valves 104, discharge valves 106, and/or other valves. For example, the compression chambers 108 may include multiple intake valves (e.g., two, three, etc.) and discharge valves (e.g., two, three, etc.). Additionally, the compressor 102 may include more than two compression chambers, two pistons, etc. In an embodiment, the compressor 102 may include more compression chambers 108 than the number of piston rods. For example, the compressor 102 may include two piston rods, but three compression chambers.

Vibration sensor(s) 118 may be installed, mounted, or otherwise disposed at any suitable location on the compressor 102. Generally, the vibration sensor(s) 118 are configured to measure perceived or experienced vibrations associated with the compressor 102. For example, the vibration sensor(s) 118 may be installed on a valve cover of the intake valves 104 and/or the discharge valves 106 of each compression chamber 108, a body (e.g., housing) of the compressor 102, etc. Alternatively, the vibration sensor(s) 118 may be installed on a body, housing, cylinder, etc., of the compressor 102. In an embodiment, given that the compressor 102 may have any number of the compression chambers 108, the vibration sensor(s) 118 may be installed on the covers of the intake valves 104 and the discharge valves 106 for the compression chambers 108, respectively. However, in an embodiment, the vibration sensor(s) 118 may be installed on the intake valves 104 and/or the discharge valves 106. In an embodiment, the vibration sensor(s) 118 may measure frequency, acceleration, displacement, etc. In an embodiment, the number of vibration sensor(s) 118 may increase a redundancy in detecting the vibrations and determining the health of the compressor 102.

As shown in FIG. 1, the vibration sensor(s) 118 may be mounted to covers of the intake valves 104 and/or the discharge valves 106. The vibration sensor(s) 118 are not individually labeled in FIG. 1. In an embodiment, vibration sensor(s) 118 may be mounted to each of the covers of the intake valves 104 and the discharge valves 106, or a subset of the covers of the intake valves 104 and the discharge valves 106 (e.g., one of the intake valves 104 or the discharge valves 106). In an embodiment, the vibration sensor(s) 118 may be similar to different compared to one another. Moreover, although a certain placement and/or number (e.g., eight) of the vibration sensor(s) 118 is shown in FIG. 1, other variations are envisioned.

A reference sensor 120 may be installed, mounted, or otherwise disposed at any suitable location on the compressor 102. In an embodiment, the reference sensor 120 may include a rod drop sensor, a proximity sensor, a pressure sensor, a tachometer (e.g., laser, magnetic, etc.), an encoder, an axial vibration sensor, or a dynamic pressure sensor. For example, as shown in a detailed view in FIG. 1, when embodied as a rod drop sensor, the reference sensor 120 may be disposed adjacent to the piston rod 116 disposed between the crankshaft 114 and the pistons of the compressor 102. When embodied as a rod drop sensor, the reference sensor 120 may measure a displacement of the piston rod 116, where the displacement is perpendicular to an axis of translation of the piston rod 116. In an embodiment, more than one of the reference sensor(s) 120 may be used. For example, a first reference sensor may be disposed adjacent to a first piston rod that extends between the crankshaft 114 and the first piston 110(1), and a second reference sensor may be disposed adjacent to a second piston rod that extends between the crankshaft 114 and the second piston 112(1). Here, two rod drop sensor(s) may be used. Alternatively, rod drop sensor(s) and an axial vibration sensor may be used for redundancy. However, in an embodiment, only one of the reference sensor(s) 120 may be used with the compressor 102, regardless of the number of the compression chambers 108.

When embodied as a rod drop sensor, the reference sensor 120 measures a distance (e.g., gap) to the piston rod 116 (e.g., between the reference sensor 120 and the piston rod 116). As the piston rod 116 moves, for example, between intake, compression, and discharge periods of the compression cycle, the rod drop sensor detects a change in position (e.g., the distance between the reference sensor 120 and the piston rod 116). The change in position measured by the reference sensor 120 may be used to determine one full compression cycle of the compressor 102 (e.g., frequency of the compressor 102). For example, throughout the compression cycle, patterns may repeat themselves within the position measured by the reference sensor 120 to understand a start and end of the compression cycle. Recognizing patterns may also be used to determine, and understand, respective portions of the compression cycle, such as intake periods, discharge periods, compression periods, etc.

In an embodiment, the vibration sensor(s) 118 and the reference sensor 120 may be components of the compressor 102. The device 100 may communicatively couple to the vibration sensor(s) 118 and the reference sensor 120 to receive sensor data 122. Although shown as receiving sensor data 122, the device 100 may additionally, or alternatively, receive signals from the vibration sensor(s) 118 and the reference sensor 120, whether unprocessed or processed. In an embodiment, the device 100 may be a component of the compressor 102 and/or may be separate from the compressor 102. For example, in the former, the device 100 may be a component of the compressor 102 that receives the sensor data 122 in real-time to permit the continuous monitoring of the compressor 102. In the latter, the device 100 may connect, whether wirelessly or through wired connections, with the vibration sensor(s) 118 and the reference sensor 120 to receive the sensor data 122.

The device 100 includes processor(s) 124 and memory 126, where the processor(s) 124 may perform various functions and operations associated with monitoring the compressor 102, and the memory 126 may store instructions executable by the processor(s) 124 to perform the operations described herein. For example, patterns in the sensor data 122 generated by the reference sensor 120 may be analyzed to determine a full compression cycle (e.g., intake, compression, discharge). The patterns may repeat themselves within the sensor data 122 to understand which periods of the compression cycle are associated with intake, compression, discharge, and so forth. In order words, at the beginning of the intake period, the piston rod 116 may be disposed a certain distance from the reference sensor 120 and at the end of the intake period, the piston rod 116 may be disposed a certain distance from the reference sensor 120. These patterns may be detected from the sensor data 122 generated by the reference sensor 120 to understand when the compressor 102 is intaking, compressing, and discharging. As such, given that the compression cycle is repetitive, patterns are recognizable through the reference sensor 120 to understand the start and end of respective compression cycles (i.e., one complete or full compression cycle).

The sensor data 122 from the vibration sensor(s) 118 and the reference sensor 120 may be generated synchronously. Capturing the sensor data 122 synchronously allows for the experienced vibrations to be correlated or otherwise associated with certain periods of the compression cycle. For example, vibrations during intake, compression, and/or discharge periods may be determined by synchronously capturing the sensor data 122 from the vibration sensor(s) 118 and the reference sensor 120. In an embodiment, a digital converter may be used to synchronize the sensor data 122. In an embodiment, when the sensor data 122 generated by the reference sensor 120 detects the start of a new compression cycle, the vibration sensor(s) 118 may be triggered to generate the sensor data 122. Given that the compressor 102 may have a plurality of vibration sensor(s) 118, the sensor data 122 generated across the plurality of vibration sensor(s) 118 may be synchronized with the sensor data 122 generated via the reference sensor 120. With this synchronization, measured vibrations are detectable at the same instances in time across the sensor data 122 generated from the vibration sensor(s) 118.

The device 100 is shown having a mapping component 128 that generates map(s) 130 from the sensor data 122. The mapping component 128 may generate the map(s) 130 that indicate the vibrations throughout the compression cycle. Throughout the compression cycle, as determined via the sensor data 122 from the reference sensor 120, the vibrations captured by the vibration sensor(s) 118 may be mapped as a function of time. This is used to understand the vibrations that occur throughout the compression cycle. For a given compression cycle, vibrations may occur during intake, compression, discharge, and so forth. The vibrations may be associated with the opening and closing of the intake valves 104 and the discharge valves 106. The map(s) 130 may indicate the timing of the vibrations (e.g., duration) as well as their intensity. The map(s) 130 may, additionally or alternatively, indicate the vibrations as a function of angular rotation of the crankshaft 114. For example, the angular position of the crankshaft 114 may be mapped from 0 to 360 degrees, and with each angular position, the vibration may be mapped accordingly.

The map(s) 130, which may represent a 2D map, graph, plot, etc., may be analyzed to determine vibrations throughout the compression cycle. For example, the map(s) 130 may have an X-axis, which represents time (e.g., in seconds) or angular position (e.g., in degrees). The map(s) 130 may have a Y-axis, which represents energy, voltage, frequency, acceleration, etc., associated with the sensor data 122 generated via the vibration sensor(s) 118. The map(s) 130 generated for each compression cycle may be compared against one another to determine patterns. Comparison of the map(s) 130 is used to determine expected vibrations during the compression cycle. For example, throughout the compression cycle, some vibrations are expected, such as during the opening and closing of the intake valves 104 and the discharge valves 106. During these periods, as represented on the X-axis, vibrations may be sensed and correspondingly mapped. The normalcy of the vibrations may be determined over time by comparing the vibrations across different compression cycles. Thresholds may be established for vibration amplitudes, as well as the period of time, or angular position, where the vibrations are expected to occur.

In an embodiment, from the map(s) 130, reference characteristic(s) are determined. The reference characteristic(s) may be associated with the expected vibration(s), both in duration and amplitude, throughout the compression cycle or during periods of the compression cycle. Moreover, as new sensor data 122 is generated, and the characteristic(s) of the vibration(s) are determined, those characteristic(s) may be compared to the reference characteristic(s) to determine whether the vibrations are expected or unexpected. For example, comparison of the map(s) 130 may also be used to determine deviations, abnormalities, etc. The detection of these deviations, such as when vibrations have amplitudes greater than the predetermined thresholds, when vibrations occur outside expected periods of time, etc., may be indicative of damaged valves. For example, the valves may flutter and lead to unexpected vibrations. These unexpected vibrations may be identified through a comparison with the reference characteristic(s). Analysis of a map 130 for a particular compression cycle may indicate unexpected vibrations by comparing the map 130 with previous map(s) 130 from previous compression cycles. When a deviation is sensed, this may be indicative of unexpected vibrations, damaged valves, and/or unhealthy valves.

In an embodiment, the severity of the damage or health of the valve may be associated with both the time and intensity of the vibration, as measured on the X and Y axis of the map 130, respectively. For example, when vibrations occur at times different than expected, or when the vibrations have amplitudes that are greater than expected, this may be indicative of an unhealthy valve. Moreover, when multiple vibration sensor(s) 118 are used, each vibration sensor 118 generates the sensor data 122 that is used to determine an associated map. The map(s) 130 associated with each vibration sensor may be compared to determine whether a vibration was detected (e.g., based on amplitude, energy, duration, etc.). In other words, a first map associated with a first vibration sensor may be compared to a second map associated with a second vibration sensor to determine whether the same vibration was sensed. This increases an accuracy in detecting vibrations, whether expected or unexpected.

In an embodiment, ML model(s) 132 may analyze the sensor data 122 for use in determining whether vibrations are expected vibrations or unexpected vibrations. The ML model(s) 132 may determine or generate damage scores 134 for the valves. The damage scores 134 may be determined by accessing the data associated with the vibration sensor(s) 118, such as the sensor data 122, providing the sensor data 122 as input to the ML model(s) 132, and generating, as output from the ML model(s) 132, the damage score 134 that is associated with the valves. The damage scores 134 may relate to a probability or likelihood that the valve needs to be replaced or maintained, or does not need to be replaced or maintained. In other words, the damage scores 134 output by the ML model(s) 132 may be machine-learned scores.

Additionally, the ML model(s) 132 may be utilized to determine deviations within the map(s) 130. For example, the ML model(s) 132 may receive the map(s) 130 and analyze the map(s) 130 to determine expected vibrations and unexpected vibrations. The ML model(s) 132 may identify characteristic(s) of the map(s) 130 and may assess the characteristics in comparison to the reference characteristics to determine expected vibrations and unexpected vibrations. For example, between a first time period and a second time period, the ML model(s) 132 may identify a first vibration or series of vibrations as an intake valve 104 opening and closing. The ML model(s) 132 may identify and compare any number of time periods to characterize the vibration(s). The ML model(s) 132 may also detect an absence of vibrations where vibrations are otherwise expected. The absence of the vibrations may be indicative of damaged valves.

While the above discussion regards ML model(s) 132 analyzing the map(s) 130, in an embodiment, the map(s) 130 may be analyzed by operators, technicians, etc. For example, technicians may observe the map(s) 130 to determine whether certain vibrations are expected or unexpected.

Machine learning generally involves processing a set of examples (called “training data”) to train a machine learning model(s). A machine learning model(s), once trained, is a learned mechanism that can receive new data as input and estimate or predict a result as output. For example, a trained machine learning model may comprise a classifier that is tasked with classifying unknown input (e.g., an unknown image) as one of multiple class labels (e.g., labeling the image as a cat or a dog). In some cases, a trained machine learning model is configured to implement a multi-label classification task (e.g., labeling images as “cat,” “dog,” “duck,” “penguin,” and so on). Additionally, or alternatively, a trained machine learning model may be trained to infer a probability, or a set of probabilities, for a classification task based on unknown data received as input. In the context of the present disclosure, the unknown input may be the sensor data 122, and the ML model(s) 132 may be tasked with outputting the damage score 134 that indicates, or otherwise relates to, a probability of the valve needing to be replaced or maintained (or not needing to be replaced or maintained). Alternatively, the ML model(s) 132 may output other scores that indicate or otherwise relate to a probably of the vibrations being unexpected vibrations or expected vibrations (e.g., within certain thresholds and ranges). Although described herein as unexpected vibrations, the ML model(s) 132 may be used to detect anomalies in the vibrations to determine the health of the valves.

In an embodiment, the vibration signals may be analyzed independent of the reference signals. For example, the ML model(s) 132 may analyze the vibration signals over periods of time, and compare the vibration signals, to determine deviations and anomalies. In this example, the reference signals may not be used to determine the start and end of a compression cycle. Comparison of the vibration signals, however, may be used to determine the anomalies.

The training data that is used to train ML model(s) 132 may include various types of data. In general, training data for machine learning may include two components, features and labels. However, the training data used to train the ML model(s) 132 may be unlabeled. Accordingly, the ML model(s) 132 may be trainable using any suitable learning technique, such as supervised learning, unsupervised learning, semi-supervised learning, reinforcement learning, and so on. The features included in the training data may be represented by a set of features, such as in the form of an n-dimensional feature vector, a 3D vector, an RGB image, etc., of quantifiable information about an attribute of the training data. The following is a list of example features that can be included in the training data for training the ML model(s) 132 described herein. However, it is to be appreciated that the following list of features is non-exhaustive, and features used in training may include additional features not described herein, and, in some cases, some, but not all, of the features listed herein. Example features included in the training data may include, without limitation, a timing (e.g., start and finish) of the vibrations, a duration (e.g., start to finish, RMS, peak to peak, min to max, etc.) of the vibrations, an occurrence of the vibrations relative to periods within the compression cycle, an intensity (e.g., peak) of the vibrations, a frequency of the vibrations, a detection of the vibrations across the vibration sensor(s) 118, and so forth. In an embodiment, the ML model(s) 132 may be trained to identify the start and end of the compression cycles. In an embodiment, the features included within the training data may be associated with valves that need replacement or maintenance, vibrations that are expected, valves that do not need replacement or maintenance, and/or vibrations that are unexpected. Moreover, the features may be for each of individual vibrations throughout the compression cycle.

In an embodiment, as part of the training process, weights may be applied to a set of features included in the training data, as derived from the historical data. In an embodiment, the weights that are set during the training process may apply to parameters that are internal to the ML model(s) 132 (e.g., weights for neurons in a hidden-layer of a neural network). These internal parameters of the ML model(s) 132 may or may not map one-to-one with individual input features of the set of features. The weights may indicate the influence that any given feature, parameter, or characteristic has on the damage score 134 output by the ML model(s) 132.

The ML model(s) 132 may represent a single model or an ensemble of base-level machine learning models, and may be implemented as any type of machine learning model. For example, suitable machine learning models for use with the techniques and systems described herein include, without limitation, neural networks, tree-based models, support vector machines (SVMs), kernel methods, random forests, splines (e.g., multivariate adaptive regression splines), hidden Markov model (HMMs), Kalman filters (or enhanced Kalman filters), Bayesian networks (or Bayesian belief networks), expectation maximization, genetic algorithms, linear regression algorithms, nonlinear regression algorithms, logistic regression-based classification models, or an ensemble thereof. An “ensemble” can comprise a collection of machine learning models whose outputs (predictions) are combined, such as by using weighted averaging or voting. The individual machine learning models of an ensemble can differ in their expertise, and the ensemble can operate as a committee of individual machine learning models that is collectively “smarter” than any individual machine learning model of the ensemble.

In an embodiment, the ML model(s) 132 may identify or determine characteristic(s) of the vibrations. The ML model(s) 132 may learn to identify complex relationships between the characteristic(s) of the vibration(s) and/or the valves. For example, the ML model(s) 132 may learn to associate certain characteristic(s) with whether the valve needs to be replaced or maintained, or whether the vibration is expected or unexpected. In an embodiment, the ML model(s) 132 may associate certain characteristic(s) with one another for use in determining whether the valve needs to be replaced or maintained, or whether the vibration is expected or unexpected. The ML model(s) 132 may compare the characteristic(s) to reference characteristic(s) to determine whether the valve needs to be replaced or maintained, or whether the vibration is expected or unexpected.

For example, the ML model(s) 132 may determine characteristic(s) of the vibration, such as the duration of the vibrations, a frequency of the vibrations, an amplitude of the vibrations, etc., and may assess these characteristic(s) in relation to the reference characteristics(s). The reference characteristic(s) may be based on the type of the compressor 102, the number of valves of the compressor 102, operating conditions of the compressor 102 (e.g., temperature, pressures, etc.), an environment of the compressor 102 (e.g., altitude, humidity, etc.), operational parameters of the compressor 102, and so forth. In an embodiment, the ML model(s) 132 may learn to identify the operational parameters of the compressor 102 when determining the reference characteristic(s). Moreover, the reference characteristic(s) may be associated with valves that are healthy and valves that are unhealthy, which may increase an accuracy in detecting both healthy valves and unhealthy valves.

The ML model(s) 132 may learn to predict which of the valves need to be replaced or maintained by attributing corresponding damage scores 134 to the individual valves. In this manner, valves with low damage scores 134, for example, (e.g., below threshold) may not need to be replaced or maintained, while valves with high damage scores (e.g., above threshold) may need to be replaced or maintained. The sensor data 122 may be used to predict when the valves need to be replaced or maintained. For example, the sensor data 122 may be used to record a history of the valves, and predictive techniques may be used to determine instances in time when the valves need to be replaced or maintained.

Although the use of a threshold is described as one example way of providing labeling (i.e., replaced or maintained), other techniques are contemplated, such as clustering algorithms, or other statistical approaches that use the trust scores may be used. The ML model(s) 132 is/are retrainable with new data in order to adapt the ML model(s) 132 to understand the valves and/or vibrations, as the characteristic(s) change, or as new correlations become available.

In an embodiment, the ML model(s) 132 may have access to, or the memory 126 may store, a scoring component 136 that generates the damage scores 134. For example, the damage scores 134 may indicate a degree by which the vibration is greater than expected vibrations or thresholds (e.g., an amount over the thresholds). In an embodiment, the damage score 134 may be output by the ML model(s) 132, and may be generated through the comparison of the characteristic(s) with the reference characteristic(s). In an embodiment, the greater the damage score 134, the more severe the damage. The damage score 134 may, therefore, be associated with the severity of the vibration and how unexpected the vibration is, whether in amplitude or duration, compared to the reference characteristic(s). Rather than generating a damage score 134, the ML model(s) may output a health score that is associated with a health of the valves.

In an embodiment, the damage scores 134 may be generated for each valve of the compressor 102. For example, knowing periods of the compression cycle that correspond to intake, compression, and discharge, certain vibrations that occur over these periods may be associated with an intake valve 104 or a discharge valve 106. This means that different portions of the compression cycle may be associated different valves, and vibrations that occur within these different portions may be used to generate a damage score 134 associated with the respective valves. Depending upon the number of compression chambers 108 in the compressor 102, the ML model(s) 132 may determine any number of damage scores 134 for the valves across the compression chambers 108.

The ML model(s) 132 may be iteratively trained an adaptive as new data becomes available. For example, initially, the ML model(s) may be trained using a first training set that includes collected sensor data from valves that are damaged and/or undamaged, as well as the characteristics of the vibrations associated therewith. The first training set may include the map(s) 130 associated with the vibrations of the valve. The ML model(s) 132 may be trained at a first stage using the first training set. In an embodiment, a second training set for a second stage of training may be generated via the first training set and valves that are incorrectly detected as being damaged or having unexpected vibrations. The ML model(s) 132 may then be trained at a second stage using the second training set. This process may repeat to increase an accuracy in the ML model(s) detecting damaged valves and undamaged valves, as well as the vibrations associated therewith.

Where a plurality of the vibration sensor(s) 118 are implemented, the ML model(s) 132 may determine the damage scores 134 from the sensor data 122 from the plurality of the vibration sensor(s) 118. In an embodiment, the damage scores 134 may be weighted, whereby sensor data 122 generated from the vibration sensor(s) 118 may be weighed more heavily. For example, when generating a damage score 134 for a first valve, a damage score 134 determined from a first vibration sensor positioned adjacent to the first valve may be weighted more heavily than a damage score 134 determined from a second vibration sensor positioned adjacent to a second valve. Here, while both the first vibration sensor and the second vibration sensor may sense the given vibration, because the first vibration sensor may be located closer in proximity to the first valve, the damage score 134 determined using the vibration signal from the first vibration sensor may be weighted more heavily than the vibration signal from the second vibration sensor. In instances in which more than one vibration sensor 118 is utilized, the damage scores 134 may be combined to generate a cumulative damage score for each valve. The damage scores 134 may be represented numerically (e.g., 0 to 100), stage (e.g., good, bad, etc.), visually (e.g., red, yellow, green, etc.), and so forth. However, rather than generating damage scores 134 for each valve, damage scores 134 may only be generated for a subset of the valves.

Additionally, rather than the damage scores 134 being associated with the valves, the damage scores 134 may be associated with the compressor 102. For example, if the compressor 102 that has multiple valves with their respective damage scores 134, the damage scores 134 may be combined to generate the damage score 134 for the compressor. In an embodiment, the damage scores 134 for the valves may be weighed, average, etc., to generate the damage score 134 for the compressor. While the damage score 134 for the compressor may indicate a health of the compressor 102 as a whole, as compared to individual valves of the compressor 102, the damage score 134 for the compressor may be overall score may be inspected to determine the health or status of individual valves.

The device 100 may communicatively couple to a remote system 138 and/or one or more additional device(s) 140. In an embodiment, based at least in part on detecting an unexpected vibration or when the damage score 134 is greater than a threshold, the device 100 may send a notification(s) 142 to the additional device(s) 140. In an embodiment, the notification(s) 142 may be audible, visual, haptic, and/or any combination thereof. Moreover, the notification(s) 142 may additionally, or alternatively, be output at the device 100, or other components of the compressor. For example, the device 100 may have I/O component(s) 148, such as a display, speaker, etc., which may output the notification(s) 142. This may serve to inform a technician to replace or service the valves, compressor 102, etc. In an embodiment, the notification(s) 142 may be output when the damage scores 134 are greater than a threshold. However, the damage scores 134 may also be output on a continual basis, even if the damage scores 134 are not greater than the threshold, to provide real-time indications as to the health of the compressor 102. In an embodiment, the device 100 may continuously transmit the signals, data, scores, etc., whether indicative of expected vibrations or unexpected vibrations, to the additional device(s) 140.

The device 100 may also be configured to transmit signals or otherwise control the operation of the compressor 102 based on the damage scores 134. For example, to prevent damage, efficiencies, etc., the device 100 may instruct the compressor 102 to power down, reduce in RPM, pressure, etc. In an embodiment, the device 100 may generate tasks associated with maintenance or service to be performed on the compressor 102. In such instances, other compressors within the environment may adjust their operational parameters to account for the adjustments. For example, a second compressor may increase its speed, pressure, etc., as a way to make up for the adjusted operational parameters of a compressor with adjusted operational parameters.

The remote system 138 may be configured to perform any or all of the operations described herein. Any level of split processing may occur between the device 100 and the remote system 138. For example, the device 100 may transmit the sensor data 122 to the remote system 138 for analysis. The remote system 138, in turn, may utilize the ML model(s) 132 to analyze the sensor data 122 in comparison to the reference signals to determine the health of the valves, the health of the compressor 102, etc. In another embodiment, the remote system 138 may be configured to train the ML model(s) 132, and may transmit the ML model(s) 132 to the device 100. Therein, as the sensor data 122 is generated, the device 100 may utilize the ML model(s) 132 to determine the damage scores 134. As yet another example, the remote system 138 may determine the damage scores 134, determine the health of the compressor 102, and transmit the notification(s) 142.

The remote system 138 may also be configured to couple to any number of the devices 100 across an environment. For example, a given environment may include any number of the compressors 102, where individual devices 100 are installed or coupled to the sensor(s) at the compressors 102. The remote system 138 may communicatively couple to these devices 100 and/or the compressors 102 as a way to monitor the environment and the health of the compressors across the environment. As such, even though FIG. 1 illustrates a single compressor, the remote system 138 may monitor a plurality of the compressor(s) 102 within the same or different environments. For example, a first channel may correspond to a rod drop sensor of a first compressor, second channels may correspond to vibration sensors of the first compressor, a third channel may correspond to a rod drop sensor of a second compressor, and fourth channels may correspond to vibration sensors of the second compressor.

The device 100 may communicatively couple to the remote system 138 and/or the additional device(s) 140 via one or more network(s) 144 (e.g., wired, wireless, etc.). The device 100 may include network interface(s) 146 (e.g., Bluetooth, Wi-Fi, etc.) for communicating over the network(s) 144. The additional device(s) 140 may include any suitable device, such as a tablet, mobile phone, laptop, wearable, computer, etc.

As used herein, a processor, such as the processor(s) 124 may include multiple processors and/or a processor having multiple cores. Further, the processor(s) 124 may comprise one or more cores of different types. For example, the processor(s) 124 may include application processor units, graphic processing units, and so forth. In one implementation, the processor(s) 124 may comprise a microcontroller and/or a microprocessor. The processor(s) 124 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 124 may possess its own local memory, which also may store program components, program data, and/or one or more operating systems.

Memory, such as the memory 126 may include volatile and nonvolatile memory, removable and non-removable media implemented in any method or technology for storage of information, such as computer-readable instructions, data structures, program component, or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s) 124. The memory 126 is an example of non-transitory computer-readable media. The memory 126 may store an operating system and one or more software applications, instructions, programs, and/or data to implement the methods described herein and the functions attributed to the various systems.

The remote system 138 may be implemented as one or more servers and may, in an embodiment, form a portion of a network-accessible computing platform implemented as a computing infrastructure of processors, storage, software, data access, etc., that is maintained and accessible via a network such as the Internet. The remote system 138 does not require end-user knowledge of the physical location and configuration of the system that delivers the services. Common expressions associated with the remote system 138 include “on-demand computing”, “software as a service (SaaS)”, “platform computing”, “network-accessible platform”, “cloud services”, “data centers”, etc. However, in an embodiment, the remote system 138 may be located within a same environment as the compressor 102.

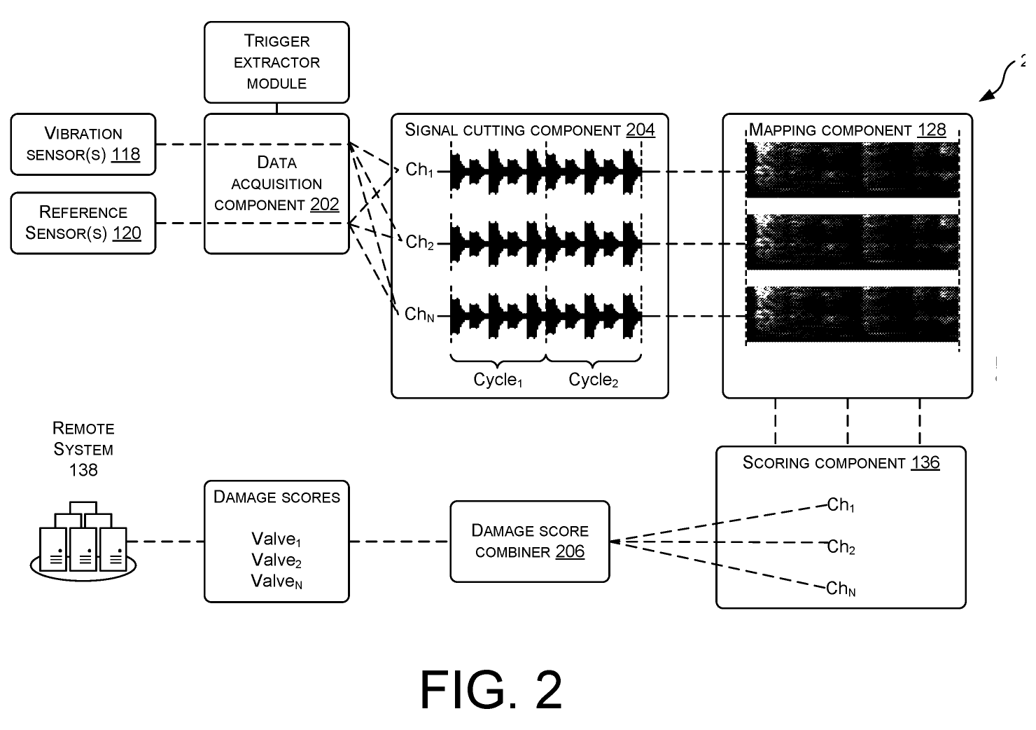

FIG. 2 illustrates an example diagram 200 associated with generating the damage scores 134, according to an embodiment of the present disclosure. The vibration sensor(s) 118 and the reference sensor 120 may generate respective signals that are received by a data acquisition component 202. While the signals may be separately received, the signals from the vibration sensor(s) 118 and the reference sensor 120 should be synchronized (e.g., based on time stamps). The device 100 may ensure that the signals are acquired in synchronization. In an embodiment, the signals may be buffered and transmitted as a batch, where the signals may be synchronized based on their time stamp. The vibration signals from the vibration sensor(s) 118 may be high-frequency vibration signals. The reference signals from the reference sensor(s) 120 may be used to determine reference points for understanding a full compression cycle. The data acquisition component 202 may also have a trigger extractor module that determines the start and end of the compression cycle. The data acquisition component 202 may be a high-frequency data acquisition system. In an embodiment, the signals from the vibration sensor(s) 118 and the reference sensor 120 may be generated between 50 and 64 KHz.

A signal cutting component 204 uses the triggers generated by the trigger extractor module to cut the vibration signals of each channel. Each of the vibration sensors 118 may have an associated channel, and the vibration signals may be cut such that a single compression cycle is determined for each of the channels. The start and end points of the compression cycle (i.e., one complete cycle, 360 degrees rotation of the crankshaft 114, etc.) may be used to cut the vibration signals. The start and end points of the compression cycle may be learned from determining the patterns in the reference signal. As an example, the vibration signals could start and end when the piston is completely at the head-end (opposite the crank-end). Cutting the signal may permit the sensor data, or the signal of each channel, to be input to the ML model(s) 132 for analysis. Cutting the signal may also increase an ease of analysis for operators viewing the map(s) 130.

The mapping component 128, which may be a 2D mapper, uses the cut vibration signals for each channel separately to generate a frequency-temporal map. Alternatively, a frequency-angular map may be generated. Any frequency analysis may be used, such as grayscale spectrograms (STFT), Wigner Ville, CWT, SSQ STFT, SSQ CWT, S-transform, etc. The map(s) 130 generated indicate the vibrations that occur through the compression cycle, whether as a function of time or angular position. In an embodiment, a map 130 may be generated for each compression cycle. Alternatively, a map 130 may be generated by averaging more than one compression cycle over a previous time interval, or over a past number of compression cycles. More example, a combiner may combine more than one map 130 to generate a map 130 that indicates the vibrations for a previous number of compression cycles.

The scoring component 136 analyzes the map(s) 130 from each of the separate channels. The scoring component 136 may generate the damage score 134 that is continuous (e.g., any value between 0 and 1), binary (e.g., 0 or 1), discrete with multiple classes (e.g., 0, 1 and 2), or multi-label cases that indicate the probability or damage of damage of the valves (e.g., 0 being unhealthy and 1 being healthy). The scoring component 136 generates the damage scores 134 for each of the valves. The ML model(s) 132 may be trained to generate the damage scores 134 by analyzing the map(s) 130 and comparing the map(s) 130 with previous map(s) 130 and/or reference characteristic(s).

The scoring component 136 may also include a damage score combiner 206 that combines the damage scores 134 generated for each of the channels into a single damage score 134 for the valves. Additionally, or alternatively, the damage score combiner 206 may generate an overall damage score for the compressor 102. In an embodiment, the damage score combiner 206 may include a voting algorithm that applies a greater weight to vibrations or damage scores 134 that are acquired on a vibration sensor 118 located closer to the valve.

The damage scores 134 may be transmitted to the remote system 138 for use in visualizations, recommendations for service, replacement, etc. The data acquisition component 202, the signal cutting component 204, the mapping component 128, the scoring component 136, and/or the damage score combiner 206 may be components of the device 100. Alternatively, the signal cutting component 204, the mapping component 128, the scoring component 136, and/or the damage score combiner 206 may be components of the remote system 138. In an embodiment, the device 100 may be configured to cut the signals (e.g., using the signal cutting component 204) and transmit the cut signals to the remote system 138. In this embodiment, the mapping component 128, the scoring component 136, and/or the damage score combiner 206 may be components of the remote system 138.

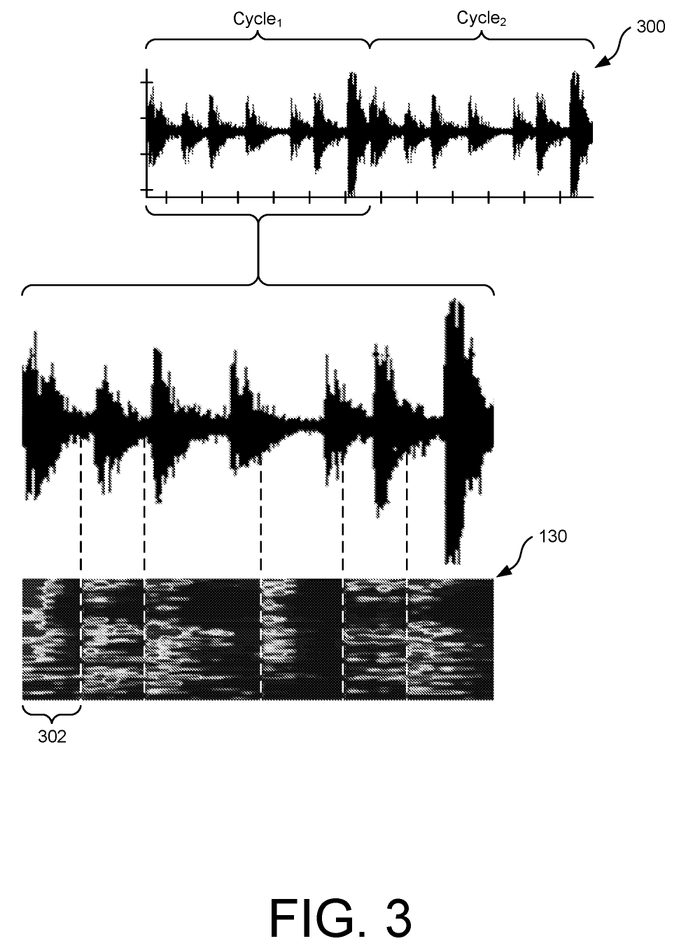

FIG. 3 illustrates an example generation of the map(s) 130, according to an embodiment of the present disclosure. In FIG. 3, a vibration signal 300 is shown, which illustrates measured vibrations associated with a compressor. The vibrations (e.g., frequency, amplitude, etc.) may be plotted along an X-axis, which may represent time or angular position. As introduced above in FIG. 2, the vibrations may be cut based on the start an end of a compression cycle. For example, in FIG. 2, two cycles are shown, where each of the cycles has its own vibrations. The start and end of each cycle may be known from the reference sensor 120 and/or determined from the ML model(s) 132.

For each of the cycles, a map is generated. For example, in FIG. 3, a map 130 is generated from cycle₁. As shown in the detailed view of cycle₁, the vibrations may be mapped in the map 130. The map 130 may be a grayscale spectrograms, where areas in the map 130 indicate the vibrations. As further shown, periods of the compression cycle may be determined, for example, from the reference sensor 120. These periods may be shown on the map 130 to understand the vibrations that occur within each period of the compression cycle.

Take, for example, vibrations that are measured over a period of time 302. The period of time 302 may be associated with a certain period of the compression cycle, such as intake. The measured vibrations may be over the period of time 302, such as between a first instance in time and a second instance in time. Between these two instances in time, the vibrations may be represented as a grayscale spectrograms, may be represented in color spectrograms, etc. Although referred to as instances in time, the vibrations may be similarly mapped relative to an angle of the crankshaft.

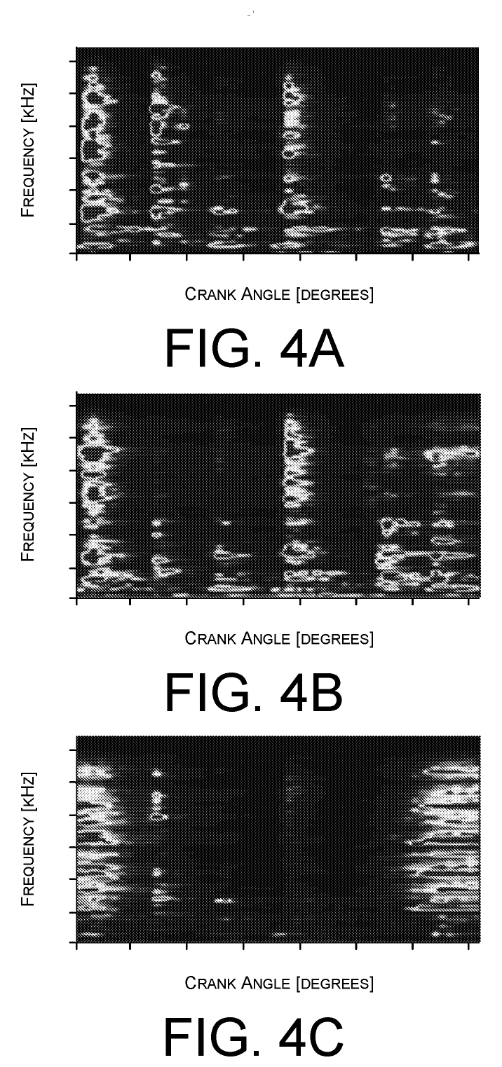

FIGS. 4A-4C illustrate example maps 130, according to an embodiment of the present disclosure. FIG. 4A illustrates a map that may be associated with a healthy compressor 102, or where the valves are not damaged. FIG. 4B may be associated with a semi-healthy compressor 102, or where the valves have a small amount of damage. FIG. 4C may be associated with an unhealthy compressor 102, or where the valves have a large amount of damage. In an embodiment, the maps 130 may be in grayscale or colors to indicate characteristics of the vibrations.

Comparison of the maps 130 may be used to understand the damage and/or generate the damage scores 134. For example, the map 130 in FIG. 4A may be used as a baseline map to which other maps 130 are compared, being as the map in FIG. 4A is associated with a healthy compressor. In comparing the maps 130 with the map 130 in FIG. 4A, the vibrations may be detected an unexpected times or intervals, and/or with an amplitude that is unexpected. For example, comparing the map in FIG. 4C with the map in FIG. 4A illustrates continuous vibrations (e.g., elevated) from approximately 300 degrees to 360 degrees. Vibrations are also generally not detected from 100 degrees to 300 degrees where vibrations are otherwise expected to occur. This too may be used to indicate that the compressor 102 associated with FIG. 4C is in need of repair or replacement.

In an embodiment, certain periods of the maps 130 may be compared to one another. For example, the compression period of the compression cycle may be compared between the map 130 in FIG. 4A and the map 130 in FIG. 4C. The comparison or analysis of a specific period within the map 130 may be used to better understand the damaged valves

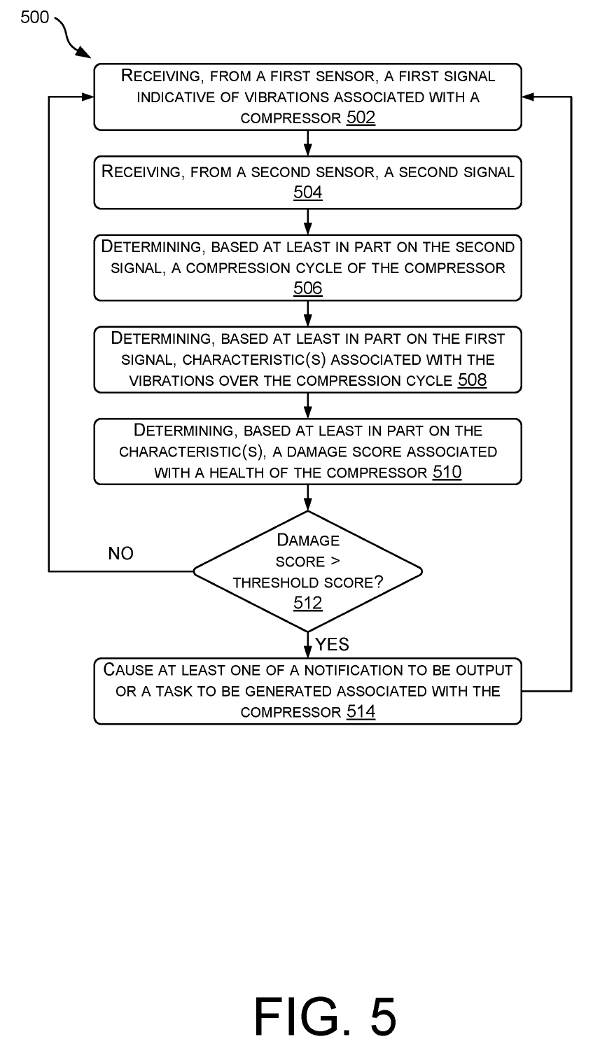

FIGS. 5-8 illustrate example processes associated with determining the health of valves within a compressor, according to an embodiment of the present disclosure. The processes described herein are illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the processes, or alternative processes, and not all of the blocks need be executed. For discussion purposes, the processes are described with reference to the environments, devices, architectures, diagrams, and systems described in the examples herein, such as, for example those described with respect to FIGS. 1-4C, although the processes may be implemented in a wide variety of other environments, architectures, and systems.

At 502, the process 500 may include receiving, from a first sensor, a first signal indicative of vibrations associated with a compressor. For example, the vibration sensor(s) 118 may generate signals, or the sensor data 122, that is associated with experienced vibration(s) on, within, or about the compressor 102. In an embodiment, the vibration sensor(s) 118 may be mounted to valve covers of the intake valves 104, the discharge valves 106, a body of the compressor 102 (e.g., ends, mid-line, etc.) in order to measure vibration(s) associated with the intake valves 104 and/or the discharge valves 106. For example, vibrations of the intake valves 104 and/or the discharge valves 106 may be imparted to the valve covers, and mounting the vibration sensor(s) 118 to the valve covers allows these vibrations to be measured.

At 504, the process 500 may include receiving, from a second sensor, a second signal. For example, the reference sensor 120 may generate a reference signal, or the sensor data 122, that is associated with the compression cycle. In an embodiment, the reference sensor 120 may be a rod drop sensor that measures a displacement of a piston rod throughout the compression cycle. The displacement may be perpendicular to an axis of translation of the piston rod. The displacement may be used to determine complete compression cycles by detecting patterns. In other words, throughout the compression cycle, patterns may be determined that are associated with the displacement of the piston rod. The first signal and the second signal may be generated synchronously.

At 506, the process 500 may include determining, based at least in part on the second signal, a compression cycle of the compressor. For example, by determining patterns in the second signal, complete compression cycles, from start to finish, may be determined. In an embodiment, start points and end points of the compression cycle may be determined (e.g., from the ML model(s) 132), and these points may be used to cut the first signal. The cutting of the first signal may separate the compression cycle from other compression cycles.

At 508, the process 500 may include determining, based at least in part on the first signal, characteristic(s) associated with the vibrations over the compression cycle. For example, by cutting the first signal, using the start point and end point as determined from the second signal, the vibrations for the compression cycle (i.e., one compression cycle) may be determined. This is accomplished at least in part by the synchronized generation of the first signal and the second signal. The characteristic(s) of the vibration(s) may be associated with duration, angular position of the crankshaft, amplitude, frequency, etc. Generally, the characteristic(s) of the vibrations indicate when the vibrations occur and their associated intensity. The characteristic(s) may also be associated with certain periods of the compression cycle, for example, knowing intake, compression, and discharge periods of the compression cycle. In an embodiment, the ML model(s) 132 may determine the characteristic(s) via generating or analyzing the map(s) 130.

At 510, the process 500 may include determining, based at least in part on the characteristic(s), a damage score associated with a health of the compressor. The damage score 134 may be determined via a comparison of the characteristic(s) to reference characteristic(s). Such comparison may indicate deviations in the frequency, duration, timing, etc., in the vibrations and whether the vibrations are expected or unexpected. The damage score may indicate an amount of deviation of the characteristic(s) relative to the reference characteristic(s). In an embodiment, if the characteristic(s) are different than the reference characteristic(s) by a threshold amount, the damage score 134 may be indicative of such. In an embodiment, the damage score 134 may be generated for the compressor 102, or for individual valves of the compressor 102.

At 512, the process 500 may include determining whether the damage score is greater than a threshold score. For example, the damage score 134 may be compared to a threshold score. The threshold score may associated with compressors 102 that need replacement or servicing. That is, if the damage score is greater than the threshold score, the compressor 102 may be in need of replacement or servicing. At 512, if the process 500 determines that the damage score 134 is not greater than the threshold score, the process 500 may follow the “NO” route and proceed to 502, whereby the process 500 may continue to receive signals from the vibration sensor(s) 118 and the reference sensor 120 for determining the health of the compressor 102. Alternatively, if at 512 the process 500 determines that the damage score 134 is greater than the threshold score, the process 500 may follow the “YES” route and proceed to 514.

At 514, the process 500 may include causing at least one of a notification to be output or a task to be generated associated with the compressor. For example, a notification(s) 142 may be output at the device 100, the compressor 102, or on the additional device(s) 140. The notification(s) 142 may indicate the damage score 134 and/or that servicing, maintenance, etc., is needed on the compressor. Alternatively, a task may be generated associated with servicing the compressor 102. As another example, when the damage score 134 is greater than the threshold score, the compressor 102 may be caused to power down, reduce in pressure, speed, etc. For example, based upon receipt of the notification(s) 142, the remote system 138 may transmit an instruction to the compressor 102 to causes one or more adjustments. Alternatively, the device 100 may transmit the instruction to the compressor 102. From 514, the process 500 may loop to 502 whereby the process 500 may continue to receive the signals from the vibration sensor(s) 118 and the reference sensor 120.

Although the process 500 is described as receiving a signal from one vibration sensor 118, the process 500 may be performed or implemented for any number of vibration sensors 118. For example, the process 500 may receive the first signals from a plurality of vibration sensors 118 and may determine the vibrations for a plurality of valves of the compressor 102.

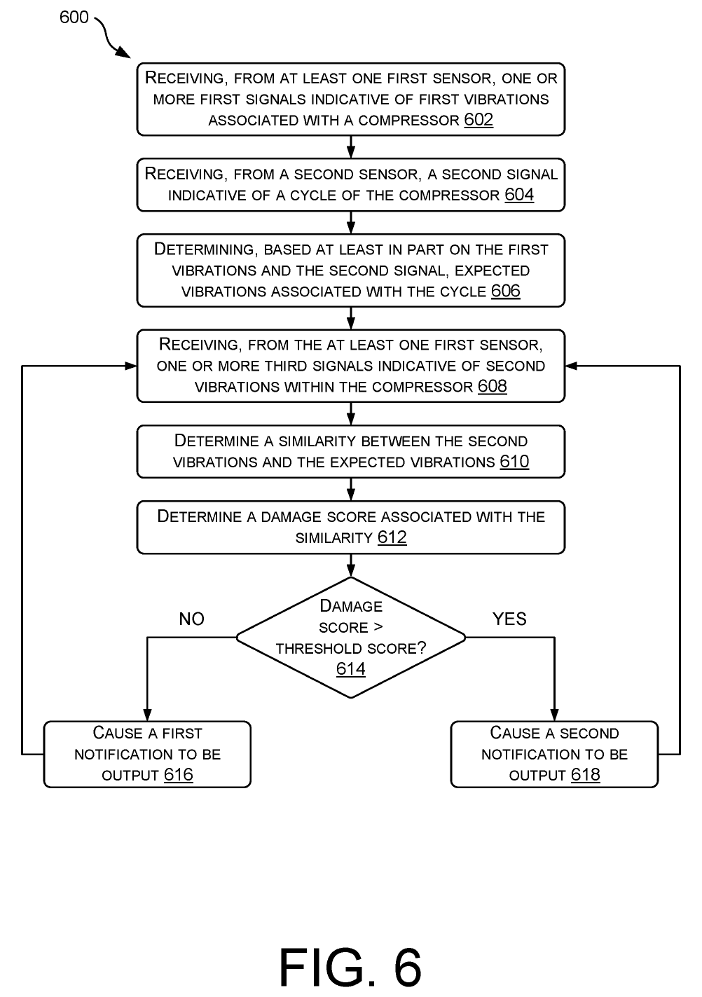

FIG. 6 illustrates an example process 600 associated with determining damage scores associated with a compressor, according to an embodiment of the present disclosure.

At 602, the process 600 may include receiving, from at least one first sensor, one or more signals indicative of first vibrations associated with a compressor. For example, the vibration sensor(s) 118 may generate signals, or the sensor data 122, that is associated with experienced vibration(s) on, within, or about the compressor 102. At least one of the vibration sensor(s) 118 may be implemented, or stated alternatively, the process 600 may receive the one or more first signals from any number of the vibration sensors disposed about the compressor 102. Moreover, the one or more first signals may be captured over a period of time.

At 604, the process 600 may include receiving, from a second sensor, a second signal indicative of a cycle of the compressor. For example, the reference sensor 120 may generate a reference signal, or the sensor data 122, that is associated with the compression cycle. The second signal may be analyzed to determine patterns throughout the compression cycle, and associating these patterns with certain periods of the compression cycle. The second signal may be generated by a rod drop sensor, where the second signal indicates a displacement of the piston rod relative to the rod drop sensor. The measured displacement may be perpendicular relative to a translational direction of the piston rod.

At 606, the process 600 may include determining, based at least in part on the first vibrations and the second signal, expected vibrations associated with the cycle. For example, the first vibrations and the second signal may be associated with one another, for example, to generate the map(s) 130. This may involve cutting the first signals using the reference points in the compression cycle from the second signal. The map(s) 130 may indicate the first vibrations as a function of time or angular position of the crankshaft. In an embodiment, the first vibrations may be associated with a healthy compressor or valves that are not damaged. As will be discussed herein, vibrations that are later experienced by the compressor 102 may be compared to the first vibrations when determining the damage score 134. In an embodiment, start points and end points of the compression cycle may be determined (e.g., from the ML model(s) 132), and these points may be used to cut the first signal. The cutting of the first signal may separate or segment the vibrations between the compression cycles.

At 608, the process 600 may include receiving, from the at least one first sensor, one or more third signals indicative of second vibrations within the compressor. For example, the vibration sensor(s) 118 may generate the third signals during operation of the compressor, where the third signals are associated with perceived vibrations. Although not shown, the reference sensor 120 may generate signals synchronously with the third signals in order to plot the vibrations.

At 610, the process 600 may include determining a similarity between the first vibrations and the second vibrations. For example, as noted above, the first vibrations may be reference vibrations to which the second vibrations are compared. A similarly between the first vibrations and the second vibrations may indicate whether the second vibrations are expected or unexpected, whether in timing, frequency, intensity, etc. In an embodiment, filters may be applied to remove deviations under different operating parameters of the compressor 102. In other words, the process 600 may account for the different operating conditions when comparing the characteristics to detect anomalies.

At 612, the process 600 may include determining a damage score associated with the similarity. For example, if the first vibrations and the second vibrations are similar, a low damage score may be determined. If the first vibrations and the second vibrations are dissimilar, a higher damage score may be generated. As such, the damage score 134 may be reflective of a similarity between the first vibrations and the second vibrations, and therefore indicative of the health of the compressor.

At 614, the process 600 may include determining whether the damage score is greater than a threshold score. For example, the damage score 134 may be compared to a threshold score. The threshold score may associated with compressors 102 that are in need of replacement or servicing. That is, if the damage score is greater than the threshold score, the compressor 102 may be in need of replacement or servicing. At 614, if the process 600 determines that the damage score 134 is not greater than the threshold score, the process 600 may follow the “NO” route and proceed to 616.

At 616, the process 600 may include causing a first notification to be output. The first notification may be output on the device 100, the compressor 102, the additional device(s) 140, etc. Generally, the first notification may serve to indicate that the compressor 102 is healthy. The first notification may be audible, visual, haptic, etc.

Alternatively, if at 614 the process 600 determines that the damage score 134 is greater than the threshold score, the process 600 may follow the “YES” route and proceed to 618. At 618, the process 600 may include causing a second notification to be output. The second notification may be different than the first notification. The second notification may be output on the device 100, the compressor 102, the additional device(s) 140, etc. Generally, the second notification may serve to indicate that the compressor 102 is unhealthy and in need of servicing.

From 616 and 618, the process 600 may loop to 608, whereby the process 600 may continue to receive signals for determining the vibrations and/or comparing the vibrations to the baseline vibrations to determine the health of the compressor 102.

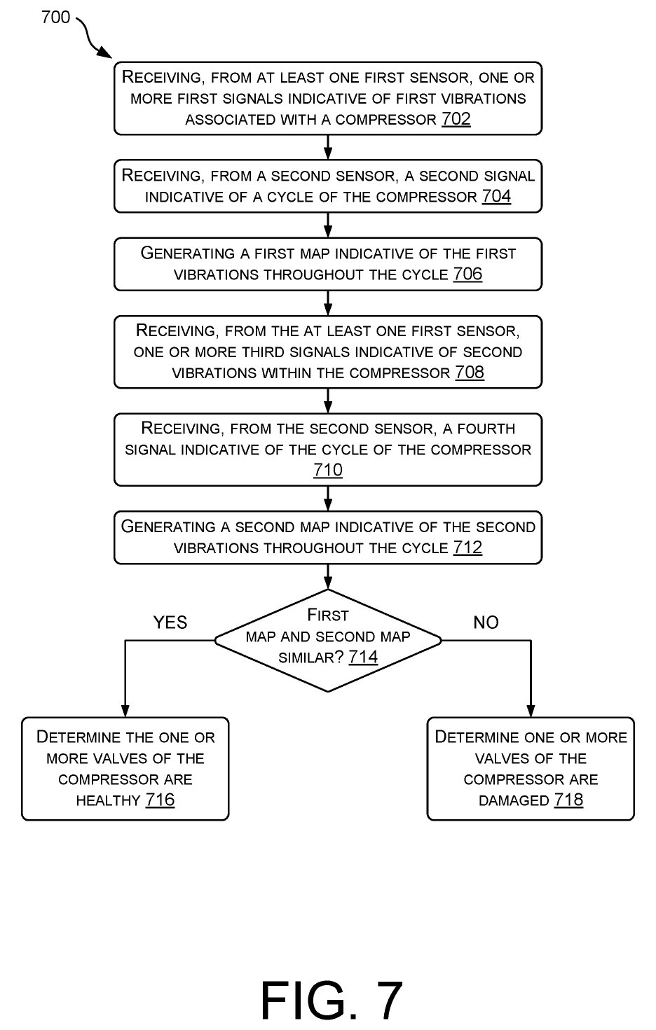

FIG. 7 illustrates an example process 700 associated within determining a health of a compressor 102, according to an embodiment of the present disclosure. At 702, the process 700 may include receiving, from at least one first sensor, one or more signals indicative of first vibrations associated with a compressor. For example, the vibration sensor(s) 118 may generate signals, or the sensor data 122, that is associated with experienced vibration(s) on, within, or about the compressor 102. Any number of the vibration sensor(s) 118 may be implemented, or stated alternatively, the process 600 may receive the one or more first signals from any number of the vibration sensors disposed about the compressor 102.

At 704, the process 700 may include receiving, from a second sensor, a second signal indicative of a cycle of the compressor. For example, the reference sensor 120 may generate a reference signal, or the sensor data 122, that is associated with the compression cycle. The second signal may be analyzed to determine patterns throughout the compression cycle, and associating these patterns with certain periods of the compression cycle.

At 706, the process 700 may include generating a first map indicative of the first vibrations throughout the cycle. For example, the mapping component 128 may generate a map that indicates, from a start to end of the cycle, the first vibrations by cutting the first signals with the start and end positions of the compression cycle indicated within the second signal. The first vibrations may be displayed as a function of time or angular position of the crankshaft 114. As such, the map 130 may indicate the measured vibrations throughout the compression cycle. In an embodiment, the first map may be associated with a baseline map that indicates expected vibrations of a healthy compressor, or a compressor with undamaged valves.

At 708, the process 700 may include receiving, from the at least one first sensor, one or more third signals indicative of second vibrations within the compressor. For example, the vibration sensor(s) 118 may generate the third signals during operation of the compressor, where the third signals are associated with perceived vibrations.

At 710, the process 700 may include receiving, from the second sensor, a second signal indicative of a cycle of the compressor. For example, the reference sensor 120 may generate a reference signal, or the sensor data 122, that is associated with the compression cycle.

At 712, the process 700 may include generating a second map indicative of the second vibrations throughout the cycle. For example, the mapping component 128 may generate a map that indicates, from a start to end of the cycle, the second vibrations. The first vibrations may be displayed as a function of time or angular position of the crankshaft 114.

At 714, the process 700 may include determining whether the first map and the second map are similar. For example, the first map and the second map may be compared to one another. As the first map may be associated with expected vibrations throughout the compression cycle, comparing the second map to the first map may indicate unexpected vibrations. For example, the comparison may indicate whether the second vibrations occurred at unexpected times, intervals, etc., and/or whether the second vibrations had amplitudes, peaks, etc., greater or less than expected. This comparison may be performed at least in part by at ML model(s) 132 and/or through an interpretation from an operator. A deviation between the second vibrations and the first vibrations may indicate unhealthy or damaged valves. In an embodiment, determining whether the first map and the second map are similar may include determining whether the first map and the second map are similar by a threshold amount.

If at 714 the process 700 determines that the first map and the second map are similar, the process 700 may follow the “YES” route and proceed to 716. At 716, the process 700 may include determining that the one or more valves of the compressor are healthy. As a result of determining that the one or more valves are healthy, the process 700 may output an notification(s) 142. Alternatively, if at 714 the process 700 determines that the first map and the second map are dissimilar, the process 700 may follow the “NO” route and proceed to 718. At 718, the process 700 may include determining that the one or more valves are unhealthy. As a result of determining that the one or more valves are unhealthy, the process 700 may output notification(s) 142. In an embodiment, if the valves are unhealthy, or otherwise damaged, the process may include causing the compressor to turn off, adjust operational parameters (e.g., RPMs, pressures, workload, amount of time running, etc.). In an embodiment, when the valves of the compressor are damaged, the process 700 may enlist the help of other compressors within the environment. For example, a first compressor with a damaged valve may power down, or adjust its operational parameters, while a second compressor with undamaged valves may adjust its operational parameters to account for the adjustment to the first compressor. The second compressor may increase its speed, pressure, etc., as a way to make up for the adjusted operational parameters of the first compressor.

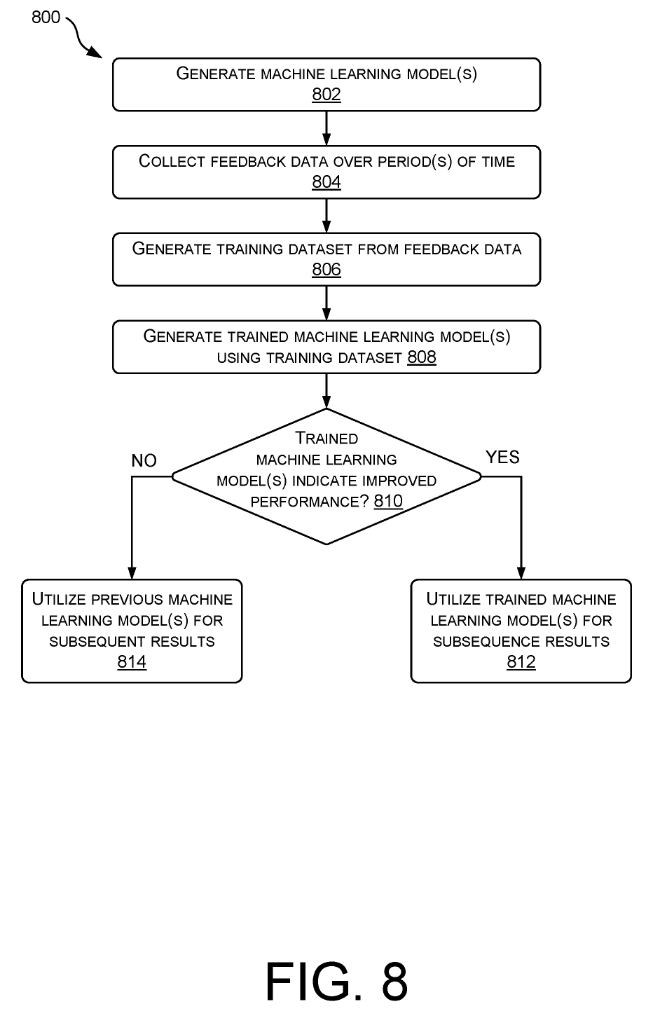

FIG. 8 is a flow diagram of an example process 800 for the generation and training of artificial intelligence models (also referred to herein as ML model(s)) to perform one or more of the processes described herein, according to an example described herein. The order in which the operations or steps are described is not intended to be construed as a limitation, and any number of the described operations may be combined in any order and/or in parallel to implement process 800.

At 802 the process 800 may include generating one or more artificial intelligence models, such as a machine learning model. A number of artificial intelligence techniques may be employed to generate and/or modify the layers and/or models described herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based artificial intelligence.

At 804 the process 800 may include collecting feedback data over a period of time. The feedback data may include any data associated with determining valve health, damage, expected vibrations, unexpected vibrations, any described with respect to FIGS. 1-4C, or any other data that may be utilized to perform the operations described herein. This information may include, for example, sensor data, characteristic(s) of the vibrations, etc.

At 806 the process 800 may include generating a training dataset from the feedback data. Generation of the training dataset may include formatting the feedback data into input vectors for the artificial intelligence model to intake, as well as associating the various data with the outcomes of the valve health, damage, expected vibrations, unexpected vibrations as described herein. The data may also be labeled accordingly.

At 808 the process 800 may include generating one or more trained artificial intelligence models utilizing the training dataset. Generation of the trained artificial intelligence models may include updating parameters and/or weightings and/or thresholds utilized by the models to determine valve health, damage, expected vibrations, unexpected vibrations, etc.

At 810 the process 800 may include determining whether the trained artificial intelligence models indicate improved performance metrics. For example, the sensor data indicative of the vibration(s) being unexpected or expected, or associated with damaged valves, are known but not to the trained artificial intelligence models. The trained artificial intelligence models may generate results, which may be compared to the known results to determine whether the results of the trained artificial intelligence model produce a superior result than the results of the artificial intelligence model prior to training.

In examples where the trained artificial intelligence models indicate improved performance metrics, the process 800 may follow the “YES” route and proceed to 812. At 812, the process 800 may include utilizing the trained artificial intelligence models for generating subsequent results. For example, the trained artificial intelligence models may be utilized to determine valve damage, unexpected versus expected vibrations, both in duration and amplitude, maintenance of the compressor, and so forth. It should be understood that the trained artificial intelligence models may be utilized in any scenario where models are utilized as described herein.

Alternative, in examples where the trained artificial intelligence models do not indicate improved performance metrics, the process 800 may follow the “NO” route and proceed to 814. At 814, the process 800 may include utilizing the previous iteration of the artificial intelligence models for generating subsequent results.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method comprising:
receiving, from a first sensor mounted to a compressor, first sensor data associated with first vibrations of the compressor;
receiving, from a second sensor, second sensor data associated with a compression cycle of the compressor, the second sensor data being generated synchronously with the first sensor data;
generating, based at least in part on the first sensor data and the second sensor data, a first map that indicates the first vibrations throughout the compression cycle;
determining, based at least in part on the compressor, a second map associated with second vibrations of the compressor;
providing, as an input to a machine-learned (ML) model, the first map and the second map;
receiving, as an output from the ML model, a score associated with damage to a valve of the compressor, the score being based at least in part on a comparison of the first map and the second map;
determining that the score satisfies a threshold score; and
causing, based at least in part on the score satisfying the threshold score, output of a notification.

2. The method of claim 1, wherein:
the second map is associated with expected vibrations throughout the compression cycle; and
the score is associated with the first vibrations being unexpected vibrations throughout the compression cycle.

3. The method of claim 1, wherein:
the first map indicates the first vibrations as a function of time or angular position of a crankshaft of the compressor; and
the second map indicates the second vibrations as a function of time or angular position of the crankshaft of the compressor.

4. The method of claim 1, further comprising receiving, from a third sensor mounted to the compressor, third sensor data associated with the first vibrations of the compressor, and wherein generating the first map is further based at least in part on the third sensor data.

5. The method of claim 1, further comprising:
receiving, from a third sensor mounted to the compressor, third sensor data associated with third vibrations of the compressor;
generating, based at least in part on the second sensor data and the third sensor data, a third map that indicates the third vibrations throughout the compression cycle;
providing, as an input to the ML model, the second map and the third map; and
receiving, as an output from the ML model, a second score associated with damage to a second valve of the compressor, the second score being based at least in part on a comparison of the second map and the third map.

6. The method of claim 5, wherein at least one of:
the first sensor is mounted to a valve cover of the valve or a body of the compressor; or
the third sensor is mounted to a valve cover of the second valve or the body of the compressor.

7. A method comprising:
receiving, from a first sensor mounted to a compressor, first sensor data associated with vibrations within the compressor;
receiving, from a second sensor mounted adjacent to a piston rod of the compressor, second sensor data associated with a displacement of the piston rod;
determining, based at least in part on the second sensor data, a start and an end of a compression cycle of the compressor;
generating, based at least in part on the first sensor data, a map that indicates the vibrations between the start and the end of the compression cycle;
determining, based at least in part on the map, one or more characteristics of the vibrations;
determining, based at least in part on the one or more characteristics, a damage to a valve; and
causing, based at least in part on determining the damage to the valve, at least one of:
an operation of the compressor to be adjusted, or
output of a notification.

8. The method of claim 7, wherein the one or more characteristics comprise at least one of:
a time interval of the vibrations;
a frequency of the vibrations;
a timing of the vibrations; or
an intensity of the vibrations.

9. The method of claim 7, wherein determining the one or more characteristics of the vibrations comprises:
providing, as an input to a machine-learned (ML) model, the first sensor data and the second sensor data; and
receiving, as an output from the ML model, the one or more characteristics.

10. The method of claim 7, further comprising determining one or more reference characteristics associated with expected vibrations within the compressor, wherein:
the one or more reference characteristics are based at least in part on operating parameters of the compressor; and
the damage to the valve is further based at least in part on comparing the one or more characteristics to the one or more reference characteristics.

11. The method of claim 7, further comprising:
receiving, from a second sensor mounted to the compressor, third sensor data associated with second vibrations within the compressor;
generating, based at least in part on the third sensor data, a second map that indicates the second vibrations between the start and the end of the compression cycle;
determining, based at least in part on the second map, one or more second characteristics of the second vibrations; and
determining, based at least in part on the one or more second characteristics, a damage to a second valve.

12. The method of claim 11, further comprising generating a score for the compressor based at least in part on the damage to the valve and the damage to the second valve.

13. The method of claim 7, further comprising:
receiving, from a second sensor mounted to a second valve cover of a second valve of the compressor, third sensor data associated with the vibrations within the compressor;
generating, based at least in part on the third sensor data, a second map that indicates the vibrations between the start and the end of the compression cycle; and
determining, based at least in part on the second map, the one or more characteristics of the vibrations.

14. The method of claim 13, wherein:
a first weight is applied to the first sensor data in determining the one or more characteristics; and
a second weight is applied to the second sensor data in determining the one or more characteristics, the second weight being less than the first weight.

15. A method comprising:
receiving, from a vibration sensor disposed on a compressor, a first signal associated with vibrations experienced by the compressor;
receiving, from a reference sensor arranged to detect a position of a piston rod of the compressor, a second signal, wherein the second signal indicates a displacement of the piston rod from the reference sensor, the displacement being perpendicular to an axis of the piston rod;
determining, based at least in part on the second signal, a compression cycle of the compressor;
determining, based at least in part on the compression cycle, a subset of the vibrations that occur within the compression cycle;
generating, based at least in part on the first signal, a map associated with the subset of the vibrations;
determining, based at least in part on the map, at least one vibration of the subset of the vibrations that is unexpected;
generating a notification associated with the at least one vibration; and
sending to notification to a device for display.

16. The method of claim 15, further comprising receiving, from a second vibration sensor disposed on the compressor, a third signal associated with the vibrations, wherein generating the map is based at least in part on the third signal.

17. The method of claim 15, further comprising:
receiving, from a second vibration sensor disposed on the compressor, a third signal associated with second vibrations;
determining, based at least in part on the compression cycle, a subset of the second vibrations that occur within the compression cycle;
generating, based at least in part on the third signal, a second map associated with the subset of the second vibrations; and
determining, based at least in part on the second map, the at least one vibration of the subset of the vibrations that is unexpected.

18. The method of claim 15, further comprising determining, based at least in part on the map, at least one of:
a timing associated with the at least one vibration;
a duration associated with the at least one vibration;
a frequency associated with the at least one vibration; or
an intensity of the at least one vibration,
wherein determining the at least one vibration of the subset of the vibrations that is unexpected is based at least in part on at least one of the timing, the duration, the frequency or the intensity.

19. The method of claim 15, further comprising determining a second map associated with expected vibrations within the compressor, wherein determining that the at least one vibration of the subset of the vibrations that is unexpected is based at least in part on comparing the map to the second map.

20. The method of claim 15, further comprising generating, based at least in part on the at least one vibration of the subset of the vibrations that is unexpected, a score associated with a damage to the compressor.
